(19) United States
(12) Patent Application Publication
(10) Pub. No.: US 2010/0223655 A1
(43) Pub. Date: Sep. 2, 2010

(54) Method, System, and Apparatus for DHCP Authentication

(75) Inventor: Ruobin ZHENG, Shenzhen (CN)

Correspondence Address: FutureWei Technologies, Inc.;IPR & Standards Department, 1700 Alma Drive, Suite 500, Plano, TX, 75075, US

(73) Assignee: HUAWEI TECHNOLOGIES CO., LTD., Shenzhen (CN)

(21) Appl. No.: 12/779,201

(22) Filed: May 13, 2010

Related U.S. Application Data
(63) Continuation of application No. PCT/CN2008/073101, filed on Nov. 19, 2008.

(30) Foreign Application Priority Data
Nov. 20, 2007 (CN) 200710169784.0

(51) Int. Cl. G06F 21/00; G06F 15/177

(52) U.S. Cl. 726/1; 709/220; 726/3

(57) ABSTRACT

A Dynamic Host Configuration Protocol (DHCP) authentication method includes: authenticating a Routing Gateway (RG) by an Authentication Server (AS) that serves the RG; receiving an access policy from a DHCP authenticator after the RG passes the authentication; and starting DHCP authentication according to the access policy, and performing DHCP authentication for a DHCP client connected to the RG. With the present invention, the DHCP authentication is started on the RG, and the DHCP authentication is performed for the DHCP client connected to the RG. Therefore, the DHCP client connected to the RG can undergo DHCP authentication through the RG to access the network.

### CROSS-REFERENCE TO RELATED APPLICATIONS

This application is a continuation of International Application No. PCT/CN2008/073101, filed on Nov. 19, 2008, which claims priority to Chinese Patent Application No. 200710169784.0, filed on Nov. 20, 2007, both of which are hereby incorporated by reference in their entireties.

### FIELD OF THE INVENTION

The present invention relates to network communication technologies, and in particular, to a method, system, and apparatus for Dynamic Host Configuration Protocol (DHCP) authentication.

### BACKGROUND OF THE INVENTION

DHCP provides a mechanism for specifying Internet Protocol (IP) addresses and configuration parameters dynamically. The configuration parameters include: allocated IP address, subnet mask, and default gateway. DHCP is primarily applied to large networks and the places where the parameters are difficult to configure. The DHCP server specifies an IP address for a client automatically. Some of the specified configuration parameters are not related to the IP protocol, and the configuration parameters make it easier for the computers on the network to communicate with each other. Because DHCP is characterized by automatic implementation of the configuration process, all configuration information may be managed by the DHCP server uniformly. The DHCP server not only allocates the IP address, but also configures plenty of other information, manages the lease of the IP address, and implements reuse of the IP address based on time. Therefore, DHCP has been applied widely now.

The members defined in the DHCP protocol include: DHCP server, DHCP relay, and DHCP client. The DHCP server is configured to provide DHCP services and allocate IP addresses or other network parameters to the client as requested by the client. The DHCP server is generally located in a router or a Layer-3 switch, or is stand-alone.

The DHCP relay is a device for transmitting DHCP messages between the DHCP server and the DHCP client, and can transmit DHCP messages for the server and the client in different network segments. The DHCP relay provides security options, and provides a mechanism for transmitting broadcast messages transparently. Therefore, the DHCP broadcast messages that cannot pass through a switch can be forwarded, and the DHCP server can provide services for the DHCP client outside its network segment. After receiving a DHCP Request message from the client, the DHCP relay adds the interface address that receives the message into the message, and then forwards the message. In this way, according to the interface address in the received message, the DHCP server can determine the subnet to which the IP address needs to be allocated.

The DHCP client is a host which uses the DHCP protocol to obtain the configuration parameters (e.g. IP address) on the network, namely, a client host or any other Layer-3 device that can obtain the IP address.

In the DHCP protocol, the DHCP messages come in the following types:

DHCP DISCOVER: The client broadcasts this message to search for an available server.

DHCP OFFER: The server uses this message to respond to the DHCP DISCOVER message sent by the client, and specify the corresponding configuration parameters.

DHCP REQUEST: The client sends this message to the server to request configuration parameters, configuration confirmation, or lease renewal.

DHCP ACK: The server sends this message to the client. This message carries configuration parameters, including the IP address.

DHCP DECLINE: The client sends this message to the server when discovering that the address is already in use.

DHCP NAK: The server sends this message to the client, indicating that the address request of the client is incorrect or that the lease has expired.

DHCP INFORM: The client uses this message to request other configuration parameters from the server when the client already has the IP address.

DHCP RELEASE: The client sends this message to the server, when the client needs to release the address.

The lease is a basis of the whole DHCP work process. A lease is specified for each IP address provided by the DHCP server. The lease is a precise terminology because the DHCP server allows a client to use an IP address in a specified period. Both the server and the client can terminate the lease anytime.

The client needs to update the lease when the client detects that 50% or more of the lease has elapsed. In this case, the client directly sends a User Datagram Protocol (UDP) packet to the server that obtains the original information of the client. The packet is a DHCP Request message designed to ask whether the Transmission Control Protocol (TCP)/Internet Protocol (IP) configuration information can be kept, and update the lease. If the server is available, the server generally sends a DHCP Ack message to the client to accept the request of the client.

When nearly 87.5% of the lease has elapsed, the client reattempts to update the lease if the client fails to update the lease in the previous request, namely, the request sent when 50% of the lease has elapsed. If this update attempt fails, the client tries contacting any DHCP server to obtain a valid IP address. If a new IP address can be allocated by another DHCP server, the client enters the binding state again. If the lease of the current IP address of the client expires, the client discards this IP address, and enters the initialization state again, and then the whole process starts over again.

The existing DHCP authentication uses two DHCPv4 messages: DHCP Auth-request, and DHCP Auth-response, or uses one DHCPv4 message: DHCP Extensible Authentication Protocol (EAP); and uses two new DHCP options: auth-proto option, and EAP-Message option. FIG. 1 shows the existing DHCP authentication process:

Step S101: When the Routing Gateway (RG) accesses the network, the RG sends a DHCP Discover message to the Broadband Network Gateway (BNG), and uses an auth-proto option to indicate the authentication mode supported by the DHCP client.

Step S102: The BNG uses the DHCP Auth-request message or DHCP EAP message to carry the EAP message to be sent to the RG, and enters the authentication process.

Step S103: After receiving the DHCP Auth-request message or DHCP EAP message, the RG sends a DHCP Auth-response message which carries the EAP message to the BNG.

Step S104: The BNG re-encapsulates the EAP message of the RG into an Authentication, Authorization, and Accounting (AAA) message, and sends the AAA message to an Authentication Server (AS).

Step S105: Finally, the AS notifies the authentication result of the DHCP server to the BNG or Internet Service Provider (ISP). If the authentication succeeds, an EAP Success message is encapsulated in the AAA message which is then sent to the BNG.

Step S106: The BNG constructs a DHCP Offer message that carries the EAP Success message, and sends the message to the RG. The “yiaddr” option in the message includes the IP address pre-allocated to the user.

Step S107: The RG sends a DHCP Request message to the BNG to request configuration parameters.

Step S108: The BNG returns a DHCP Ack message to the RG. The message carries the configuration parameters, including the IP address.

During the implementation of the present invention, the inventor finds at least the following defects in the prior art:

When the gateway is an RG, that is, the RG is a Layer-3 device, the existing DHCP authentication broadcast message (such as DHCP Discover) is unable to traverse the RG, and it is impossible to perform DHCP authentication for the client after the RG.

### SUMMARY OF THE INVENTION

The embodiments of the present invention provide a method, system, and apparatus for DHCP authentication so that the DHCP client connected to the RG can undergo DHCP authentication through the RG and access the network.

A DHCP authentication method provided in an embodiment of the present invention includes:

authenticating an RG through an AS that serves the RG;

receiving an access policy from a DHCP authenticator after the RG passes the authentication; and

starting DHCP authentication according to the access policy, and performing DHCP authentication for a DHCP client connected to the RG.

An RG provided in an embodiment of the present invention includes:

an authentication requesting module, configured to enable an AS that serves the RG to authenticate the RG;

a policy storing module, connected to the authentication requesting module, and configured to: store an access policy from a DHCP authenticator into an Enforcement Point (EP) function module after the RG passes the authentication; and

the EP function module, configured to store and execute the access policy from the DHCP authenticator.

An IP edge node provided in an embodiment of the present invention includes:

a DHCP authentication agent function module, configured to: forward a DHCP authentication message, and forward a message which comes from an RG and carries a DHCP Discover message in broadcast or unicast mode; and

a DHCP authenticator module, configured to send a DHCP forced-update message to the DHCP client.

A DHCP authentication system provided in an embodiment of the present invention includes:

an RG, configured to: receive an access policy from a DHCP authenticator after being authenticated by an AS that serves the RG, start DHCP authentication according to the access policy, and perform the DHCP authentication for a DHCP client connected to the RG; an IP edge node, configured to: forward a DHCP authentication message, forward a message that comes from the RG and carries a DHCP Discover message in broadcast or unicast mode, forward a DHCP forced-update message to the DHCP client, and deliver the access policy to the RG; and

the AS, configured to authenticate the RG that the AS serves.

Compared with the prior art, the embodiments of the present invention bring the following benefits: Through the embodiments of the present invention, the DHCP authentication is started on the RG, and the DHCP authentication is performed for the DHCP client connected to the RG. In this way, the DHCP client connected to the RG can undergo DHCP authentication through the RG to access the network.

### BRIEF DESCRIPTION OF THE DRAWINGS

FIG. 1 is a flowchart of DHCP authentication in the prior art;

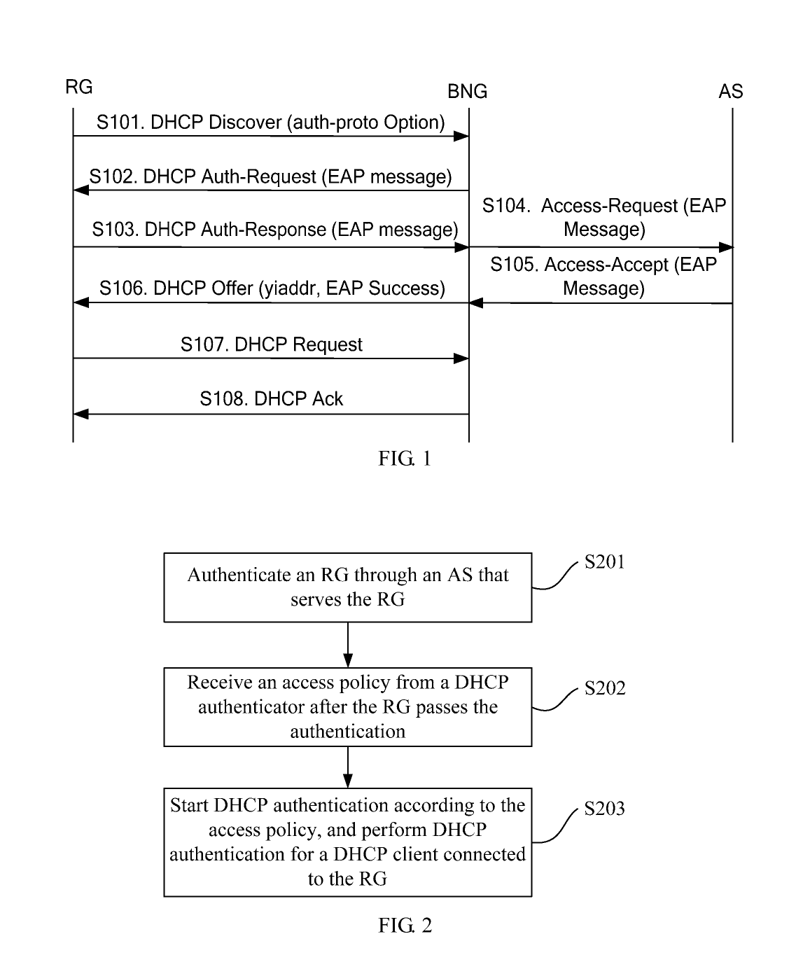

FIG. 2 is a flowchart of a DHCP authentication method in an embodiment of the present invention;

FIG. 3 is a flowchart of a DHCP authentication method in a first embodiment of the present invention;

FIG. 4 shows an RG that supports DHCP AS functions in an embodiment of the present invention;

FIG. 5 is a flowchart of a DHCP authentication method in a second embodiment of the present invention;

FIG. 6(a) and FIG. 6(b) show an RG that supports DHCP authentication agent functions in an embodiment of the present invention;

FIG. 7 is a flowchart of a DHCP authentication method in a third embodiment of the present invention;

FIG. 8 is a flowchart of a DHCP authentication method in a fourth embodiment of the present invention;

FIG. 9 is a flowchart of a DHCP authentication method in a fifth embodiment of the present invention;

FIG. 10 is a flowchart of a DHCP authentication method in a sixth embodiment of the present invention; and

FIG. 11 shows a structure of a DHCP authentication system in an embodiment of the present invention.

### DETAILED DESCRIPTION OF THE EMBODIMENTS

The embodiments of the present invention provide a DHCP authentication method, which performs DHCP authentication for the DHCP client connected to the RG after starting the DHCP authentication on the RG. In this way, the DHCP client connected to the RG can undergo DHCP authentication through an RG to access the network. After the DHCP AS functions or DHCP authentication agent functions are configured on the RG, the DHCP authentication message can traverse the IP node. Therefore, the DHCP authentication message traverses different IP domains, thus making it possible to implement cross-IP domain wholesale services and laying a technical foundation for the next-generation IP-based access network.

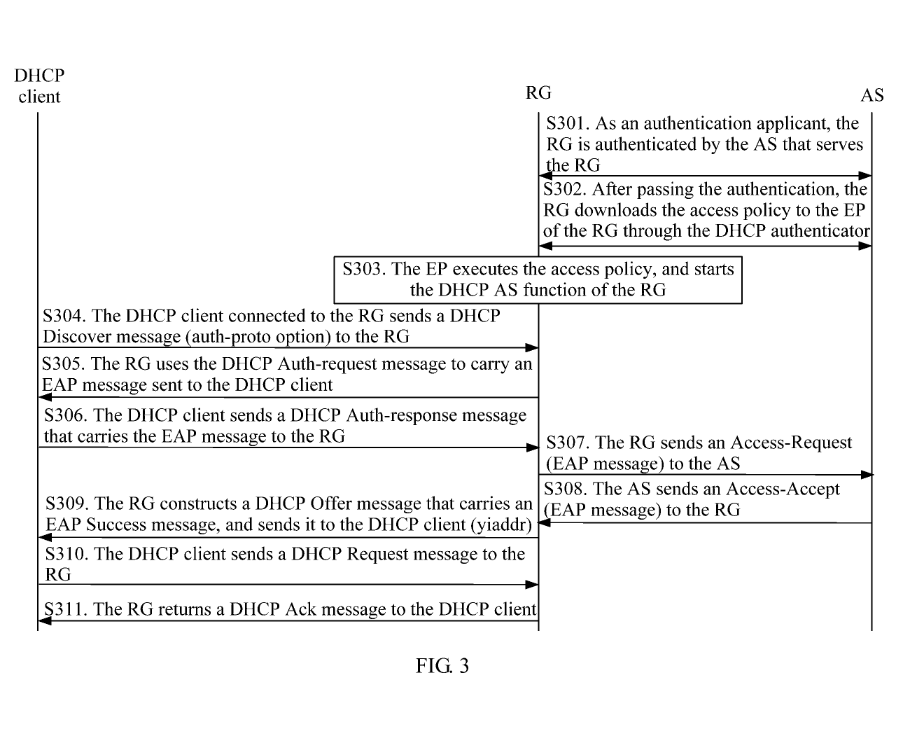

FIG. 2 is a flowchart of a DHCP authentication method in an embodiment of the present invention. The method includes the following steps:

Step S201: Authenticate an RG by an AS that serves the RG. The RG supports dual authentication and the EP function. As a suppliant, the RG is authenticated by the AS that serves the RG.

Step S202: Receive an access policy from a DHCP authenticator after the RG passes the authentication. After passing authentication, the RG downloads the access policy to the EP function module of the RG from the DHCP authenticator, and configures DHCP AS functions or DHCP authentication agent functions on the RG. The DHCP AS functions or DHCP authentication agent functions on the RG may also be configured statically.

Step S203: Start DHCP authentication according to the access policy, and perform DHCP authentication for the DHCP client connected to the RG so that the DHCP client behind the RG can undergo DHCP authentication through the RG to access the network. The EP function module of the RG executes the access policy which is downloaded by the RG or configured on the RG statically, starts the DHCP authentication of the RG, namely, starts the DHCP AS function or DHCP authentication agent function of the RG, and performs DHCP authentication for the DHCP client connected to the RG.

The RG affixes different Virtual Local Area Network (VLAN) tags to the messages of different authentication attempts, for example, affixes VLAN1 to the message of the first authentication attempt, and affixes VLAN2 to the message of the second authentication attempt. The IP edge node differentiates between different authentication attempts according to the VLAN tag, and decides whether to send the authentication message to the DHCP authentication agent module or the DHCP authenticator function module. For example, the VLAN1 authentication message is sent to the DHCP authenticator function module, and the VLAN2 authentication message is sent to the DHCP authentication agent function module.

After the DHCP client connected to the RG undergoes the DHCP authentication, the network side or the DHCP client may trigger a re-authentication process. In this case, the DHCP authentication agent forwards the DHCP authentication message for the DHCP client and the DHCP authenticator/DHCP server.

Through the foregoing DHCP authentication method, the DHCP AS function or DHCP authentication agent function is configured on the RG so that the DHCP client connected to the RG can undergo DHCP authentication through the RG to access the network. After the DHCP AS function or DHCP authentication agent function is configured on the RG, the DHCP authentication message can traverse the IP node. Therefore, the DHCP authentication message traverses different IP domains, thus making it possible to implement cross-IP domain wholesale services and laying a technical foundation for the next-generation IP-based access network.

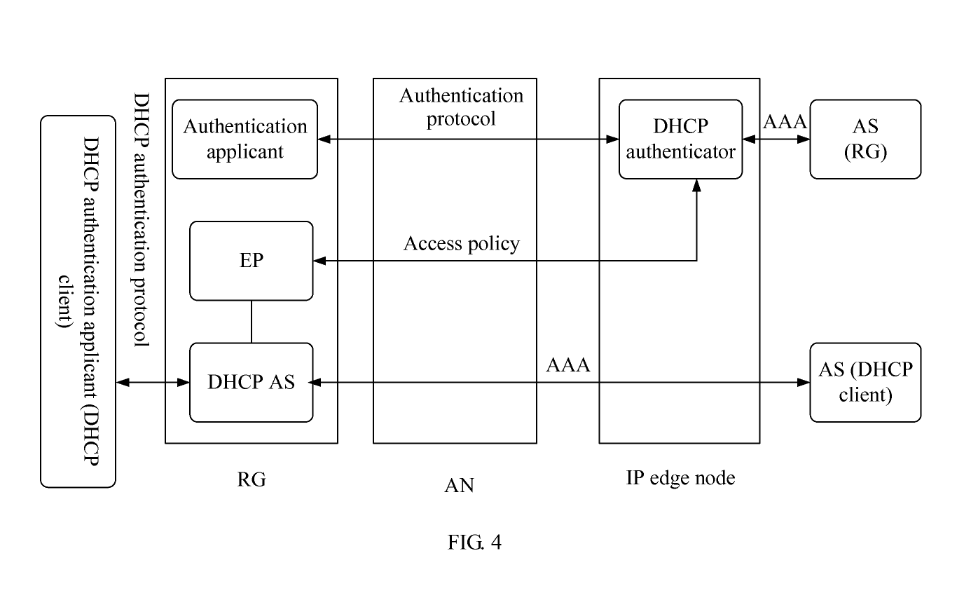

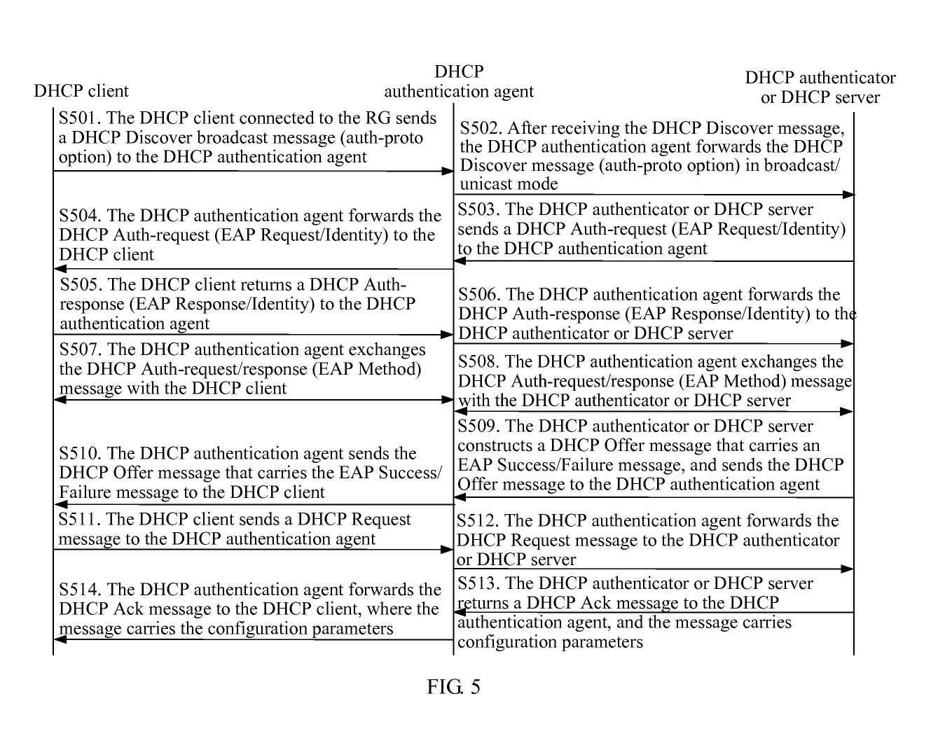

FIG. 3 is a flowchart of a DHCP authentication method in a first embodiment of the present invention. An RG that supports the DHCP AS function is provided in this embodiment. FIG. 4 shows connections between the RG and the access network, between the RG and the IP edge node, and between the RG and the AS. In this way, the DHCP client connected to the RG can undergo DHCP authentication performed by the DHCP AS on the RG to access the network.

Preferably, the RG supports dual authentication and the EP function. As a suppliant, the RG is authenticated by the AS that serves the RG. After the RG passes the authentication, the RG downloads the access policy to the EP of the RG from the authenticator. The EP executes the access policy, starts the DHCP AS function of the RG, and then performs DHCP authentication for the client after the RG. The detailed steps are as follows:

Step S301: As a suppliant, the RG is authenticated by the AS that serves the RG. The RG authentication may be DHCP authentication.

Step S302: After passing the authentication, the RG downloads the access policy to the EP of the RG from the authenticator.

Step S303: The EP executes the access policy, and starts the DHCP AS function of the RG.

Step S304: The DHCP client connected to the RG sends a DHCP Discover message to the RG. The DHCP Discover message carries an auth-proto option.

Step S305: The RG uses the DHCP Auth-request message to carry an EAP message sent to the DHCP client, and enters the authentication process.

Step S306: After receiving the DHCP Auth-request message, the DHCP client sends a DHCP Auth-response message that carries an EAP message to the RG.

Step S307: The RG sends an Access-Request that carries the EAP message to the AS.

Step S308: The AS sends an Access-Accept message that carries the EAP message to the RG.

Step S309: The RG constructs a DHCP Offer message that carries an EAP Success message, and sends the DHCP Offer message to the DHCP client. The “yiaddr” option in the message includes the IP address pre-allocated to the user.

Step S310: The DHCP client sends a DHCP Request message to the RG to request configuration parameters.

Step S311: The RG returns a DHCP Ack message to the DHCP client. The message carries the configuration parameters, including the IP address.

The DHCP AS function may be configured on the RG statically. In this case, step S301 and step S302 are omissible.

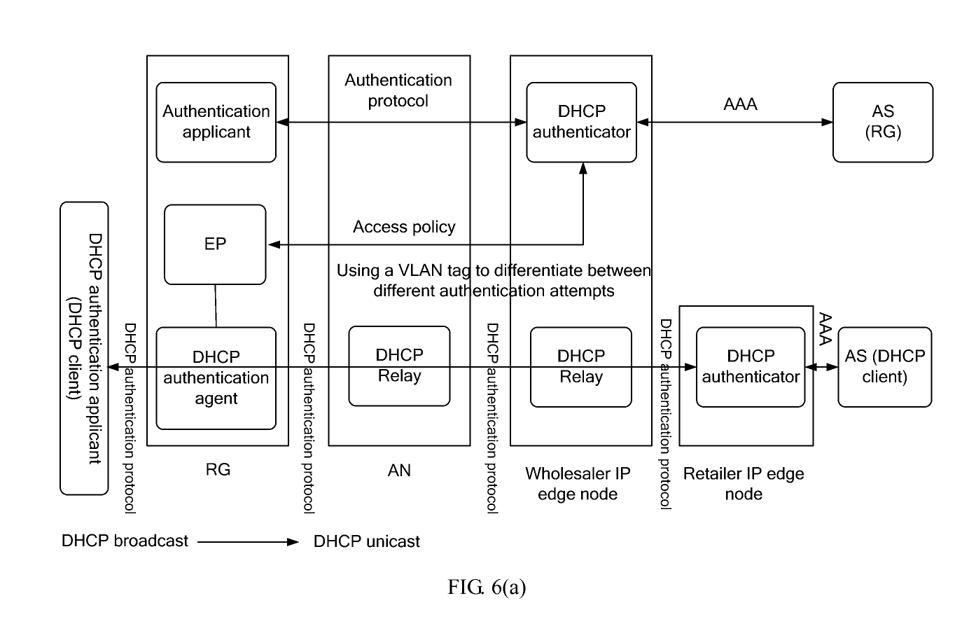

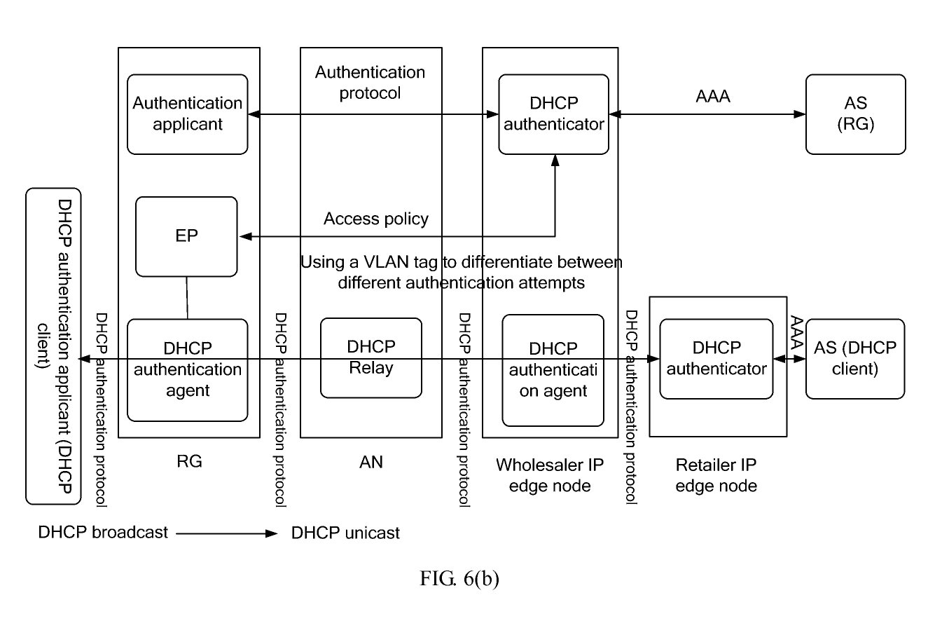

FIG. 5 is a flowchart of a DHCP authentication method in the second embodiment of the present invention. As shown in FIG. 6(a), an RG that supports the DHCP authentication agent function is put forward in this embodiment so that the DHCP client connected to the RG can undergo DHCP authentication performed by the DHCP authentication agent on the RG and access the network.

As shown in FIG. 6(b), if any IP node other than the DHCP authenticator and the DHCP server exists between the DHCP client and the DHCP authenticator or DHCP server, the IP node needs to support the DHCP authentication agent function. An IP edge node that supports the DHCP authentication agent function and the DHCP authenticator function is put forward in this embodiment to forward DHCP authentication messages so that the DHCP authentication messages can traverse the IP node. The RG allocates a different VLAN tag for the message of each authentication attempt, for example, affixes VLAN1 to the message of the first authentication attempt, and affixes VLAN2 to the message of the second authentication attempt. In this way, the IP edge node differentiates between different authentication attempts according to the VLAN tag, and decides whether to send the authentication message to the DHCP authentication agent function module or to the DHCP authenticator function module. For example, the authentication message with a VLAN1 tag is sent to the DHCP authenticator function module, and the authentication message with a VLAN2 tag is sent to the DHCP authentication agent function module.

Preferably, before authentication, the RG supports dual authentication and the EP function. As a suppliant, the RG is authenticated by the AS that serves the RG. After the RG passes the authentication, the RG downloads the access policy to the EP of the RG from the authenticator. The EP executes the access policy, starts the DHCP authentication agent function of the RG, and then performs DHCP authentication for the DHCP client connected to the RG.

Step S501: The DHCP client connected to the RG sends a DHCP Discover broadcast message to the DHCP authentication agent. The DHCP Discover broadcast message carries an auth-proto option.

Step S502: After receiving the DHCP Discover message, the DHCP authentication agent still forwards the DHCP Discover message in broadcast mode, and modifies the source address of the message that carries the DHCP Discover message to the address of the DHCP authentication agent.

Alternatively, after receiving the DHCP Discover message, the DHCP authentication agent forwards the DHCP Discover message in unicast mode, modifies the source address of the message that carries the DHCP Discover message to the address of the DHCP authentication agent, and modifies the destination address of the message that carries the DHCP Discover message to the address of the next hop IP node, which is generally the address of the DHCP authenticator or DHCP server; if the next hop IP node is not the DHCP authenticator or DHCP server, the next hop IP node needs to support the DHCP authentication agent function, for example, the IP edge node in FIG. 6(b).

The address of the next hop IP node is downloaded to the RG through the authentication protocol after the RG passes the authentication, and serves the purpose of changing from broadcast to unicast.

Step S503: The DHCP authenticator or DHCP server sends a DHCP Auth-request message that carries an EAP request/identity to the DHCP authentication agent.

Step S504: The DHCP authentication agent forwards the DHCP Auth-request message that carries the EAP request/identity to the DHCP client.

Step S505: The DHCP client returns a DHCP Auth-response message that carries an EAP response/identity message to the DHCP authentication agent.

Step S506: The DHCP authentication agent forwards the DHCP Auth-response message that carries the EAP response/identity message to the DHCP authenticator or DHCP server.

Step S507: The DHCP authentication agent exchanges the DHCP Auth-request/Auth-response message that carries the EAP Method with the DHCP client.

Step S508: The DHCP authentication agent exchanges the DHCP Auth-request/Auth-response message that carries the EAP Method with the DHCP authenticator or DHCP server.

Step S509: The DHCP authenticator or DHCP server constructs a DHCP Offer message that carries an EAP Success/Failure message, and sends the DHCP Offer message to the DHCP authentication agent.

Step S510: The DHCP authentication agent sends the DHCP Offer message that carries the EAP Success/Failure message to the DHCP client.

Step S511: The DHCP client sends a DHCP Request message to the DHCP authentication agent to request configuration parameters.

Step S512: The DHCP authentication agent forwards the DHCP Request message to the DHCP authenticator or DHCP server.

Step S513: The DHCP authenticator or DHCP server returns a DHCP Ack message to the DHCP authentication agent. The message carries configuration parameters, including an IP address.

Step S514: The DHCP authentication agent forwards the DHCP Ack message to the DHCP client. The message carries the configuration parameters, including the IP address.

The foregoing DHCP authentication method differs from the prior art in that: The DHCP authentication broadcast message in the prior art is unable to traverse the RG; this embodiment introduces a DHCP authentication agent as a forwarder of the DHCP authentication message, especially, a forwarder of the DHCP authentication broadcast message, for example, the DHCP Discover message for the purpose of authentication.

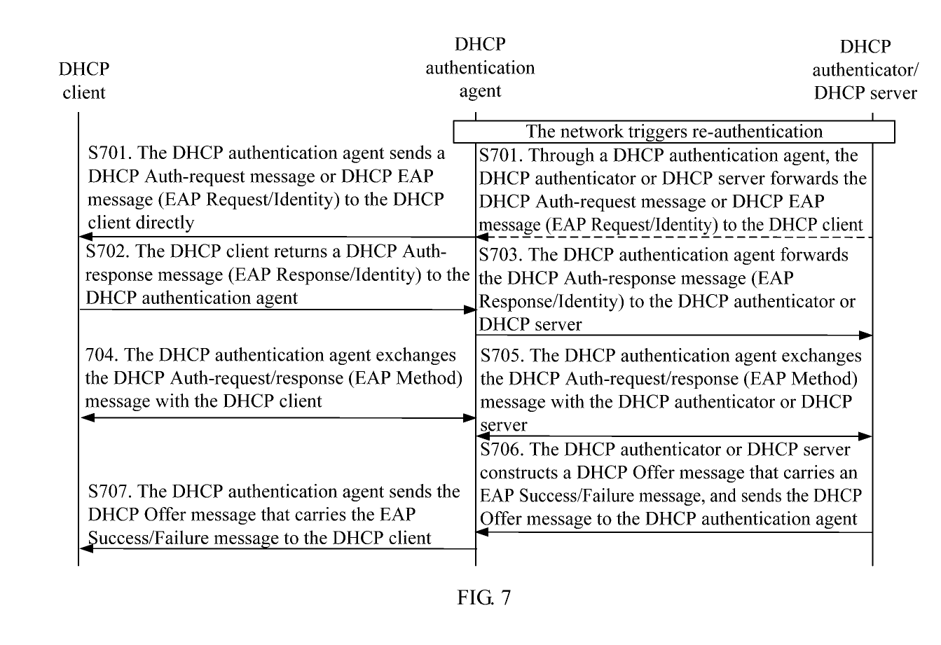

FIG. 7 is a flowchart of a DHCP authentication method in the third embodiment of the present invention. A re-authentication process is triggered by expiry of the re-authentication timer at the network side, or by another event at the network side. The re-authentication process includes the following steps:

Step S701: The DHCP authentication agent directly sends a DHCP Auth-request message or DHCP EAP message to the DHCP client to initiate a re-authentication process, where the message carries an EAP request/identity message sent to the DHCP client; or, through a DHCP authentication agent, the DHCP authenticator or DHCP server forwards the DHCP Auth-request message or DHCP EAP message to the DHCP client to initiate a re-authentication process, namely, a process of setting up the IP session again, where the message carries the EAP request/identity message sent to the DHCP client.

Step S702: The DHCP client returns a DHCP Auth-response message that carries an EAP response/identity message to the DHCP authentication agent.

Step S703: The DHCP authentication agent forwards the DHCP Auth-response message that carries the EAP response/identity message to the DHCP authenticator or DHCP server.

Step S704: The DHCP authentication agent exchanges the DHCP Auth-request/Auth-response message that carries the EAP Method with the DHCP client.

Step S705: The DHCP authentication agent exchanges the DHCP Auth-request/Auth-response message that carries the EAP Method with the DHCP authenticator or DHCP server.

Step S706: The DHCP authenticator or DHCP server constructs a DHCP Offer message that carries an EAP Success/Failure message, and sends the DHCP Offer message to the DHCP authentication agent.

Step S707: The DHCP authentication agent sends the DHCP Offer message that carries the EAP Success/Failure message to the DHCP client.

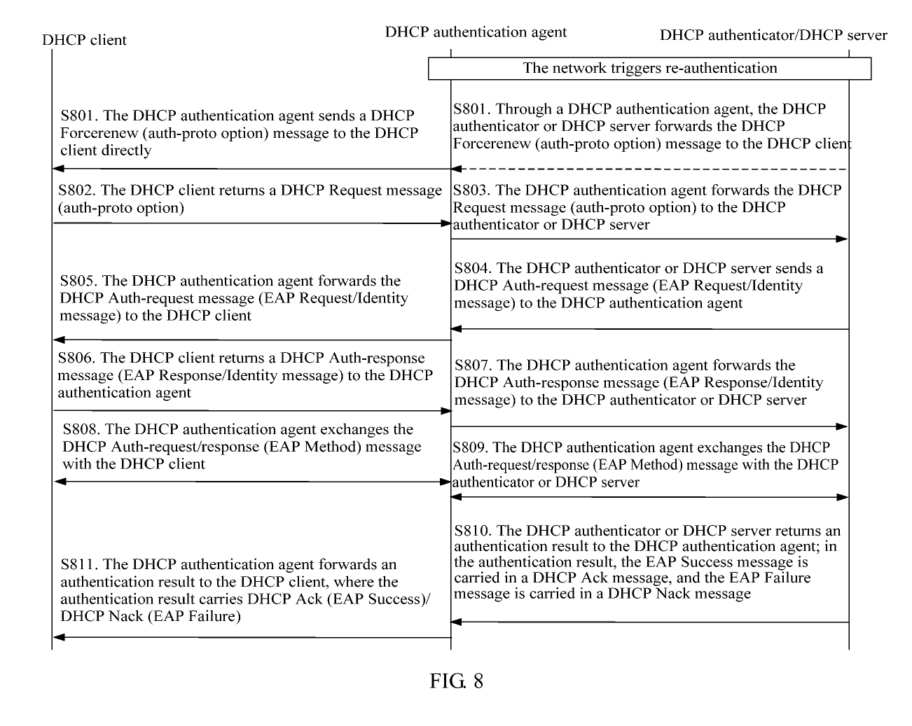

FIG. 8 is a flowchart of a DHCP authentication method in the fourth embodiment of the present invention. A re-authentication process is triggered by expiry of the re-authentication timer at the network side, or by another event at the network side. The re-authentication process includes the following steps:

Step S801: The DHCP authentication agent directly sends a DHCP forced-update message that carries an auth-proto option to the DHCP client, requiring the DHCP client to undergo re-authentication; or, through a DHCP authentication agent, the DHCP authenticator or DHCP server forwards the DHCP forced-update message that carries the auth-proto option to the DHCP client, requiring the DHCP client to undergo a re-authentication process, namely, a process of setting up the IP session again.

Step S802: The DHCP client returns a DHCP Request message that carries the auth-proto option, indicating that the DHCP client is ready for re-authentication and that the DHCP authenticator or DHCP server can initiate re-authentication.

Step S803: The DHCP authentication agent forwards the DHCP Request message that carries the auth-proto option to the DHCP authenticator or DHCP server.

Step S804: The DHCP authenticator or DHCP server sends a DHCP Auth-request message that carries an EAP request/identity message to the DHCP authentication agent.

Step S805: The DHCP authentication agent forwards the DHCP Auth-request message that carries the EAP request/identity message to the DHCP client.

Step S806: The DHCP client returns a DHCP Auth-response message that carries an EAP response/identity message to the DHCP authentication agent.

Step S807: The DHCP authentication agent forwards the DHCP Auth-response message that carries the EAP response/identity message to the DHCP authenticator or DHCP server.

Step S808: The DHCP authentication agent exchanges the DHCP Auth-request/Auth-response message that carries the EAP Method with the DHCP client.

Step S809: The DHCP authentication agent exchanges the DHCP Auth-request/Auth-response message that carries the EAP Method with the DHCP authenticator or DHCP server.

Step S810: The DHCP authenticator or DHCP server returns an authentication result to the DHCP authentication agent. In the authentication result, the EAP Success message is carried in a DHCP Ack message, and the EAP Failure message is carried in a DHCP Nack message. The DHCP Ack message carries an IP address, which may be an IP address reallocated by the DHCP authenticator or DHCP server to the DHCP client or may be the IP address obtained by the DHCP client through the first authentication.

Step S811: The DHCP authentication agent forwards the authentication result to the DHCP client. In the authentication result, the EAP Success message is carried in a DHCP Ack message, and the EAP Failure message is carried in a DHCP Nack message. The DHCP Ack message carries an IP address, which may be the IP address reallocated by the DHCP authenticator or DHCP server to the DHCP client or may be the IP address obtained by the DHCP client through the first authentication.

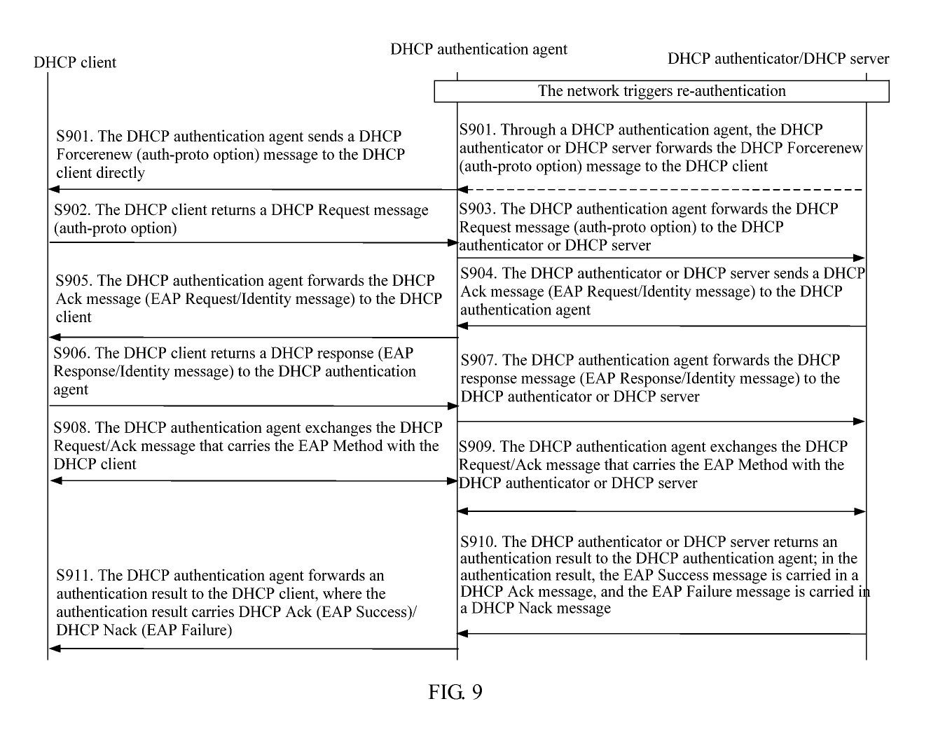

FIG. 9 is a flowchart of a DHCP authentication method in the fifth embodiment of the present invention. A re-authentication process is triggered by expiry of the re-authentication timer at the network side, or by another event at the network side. The re-authentication process includes the following steps:

Step S901: The DHCP authentication agent directly sends a DHCP forced-update message that carries an auth-proto option to the DHCP client, requiring the DHCP client to undergo re-authentication; or, through a DHCP authentication agent, the DHCP authenticator or DHCP server forwards the DHCP forced-update message that carries the auth-proto option to the DHCP client, requiring the DHCP client to undergo a re-authentication process, namely, a process of setting up the IP session again.

Step S902: The DHCP client returns a DHCP Request message that carries the auth-proto option, indicating that the DHCP client is ready for re-authentication and that the DHCP authenticator or DHCP server can initiate re-authentication.

Step S903: The DHCP authentication agent forwards the DHCP Request message that carries the auth-proto option to the DHCP authenticator or DHCP server.

Step S904: The DHCP authenticator or DHCP server sends a DHCP Ack message that carries an EAP request/identity message to the DHCP authentication agent.

Step S905: The DHCP authentication agent forwards the DHCP Ack message that carries the EAP request/identity message to the DHCP client.

Step S906: The DHCP client returns a DHCP Auth-response message that carries an EAP response/identity message to the DHCP authentication agent.

Step S907: The DHCP authentication agent forwards the DHCP Auth-response message that carries the EAP response/identity message to the DHCP authenticator or DHCP server.

Step S908: The DHCP authentication agent exchanges the DHCP Request/Ack message that carries the EAP Method with the DHCP client.

Step S909: The DHCP authentication agent exchanges the DHCP Request/Ack message that carries the EAP Method with the DHCP authenticator or DHCP server.

Step S910: The DHCP authenticator or DHCP server returns an authentication result to the DHCP authentication agent. In the authentication result, the EAP Success message is carried in a DHCP Ack message, and the EAP Failure message is carried in a DHCP Nack message. The DHCP Ack message carries an IP address, which may be an IP address reallocated by the DHCP authenticator or DHCP server to the DHCP client or may be the IP address obtained by the DHCP client through the first authentication.

Step S911: The DHCP authentication agent forwards the authentication result to the DHCP client. In the authentication result, the EAP Success message is carried in a DHCP Ack message, and the EAP Failure message is carried in a DHCP Nack message. The DHCP Ack message carries an IP address, which may be the IP address reallocated by the DHCP authenticator or DHCP server to the DHCP client or may be the IP address obtained by the DHCP client through the first authentication.

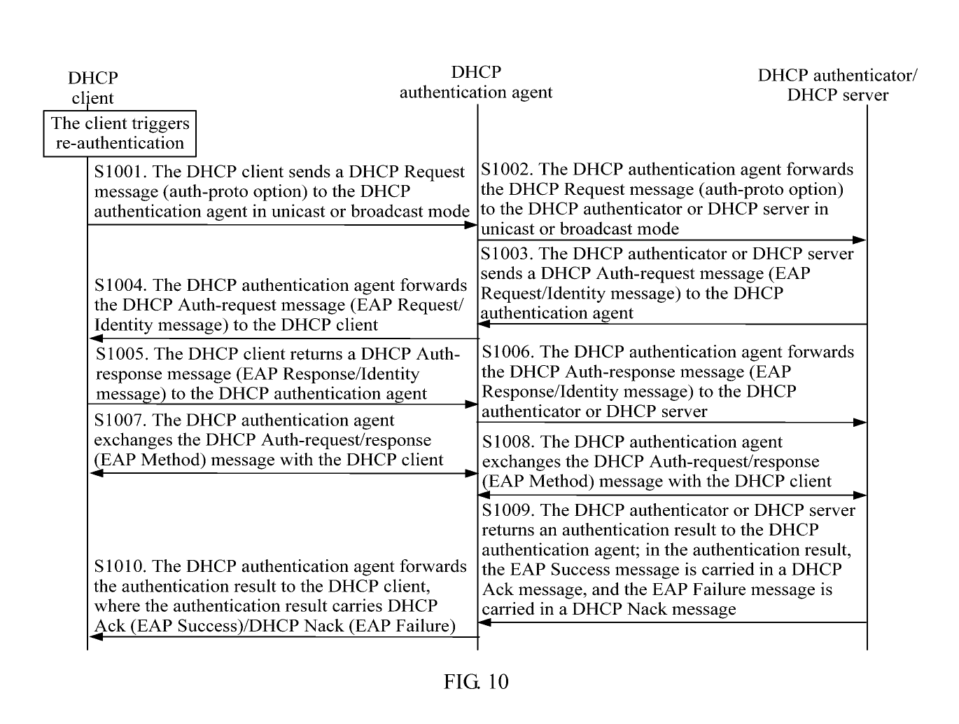

FIG. 10 is a flowchart of a DHCP authentication method in the sixth embodiment of the present invention. Re-authentication is triggered by expiry of the re-authentication timer at the client side, or by another event at the client side. The re-authentication process includes the following steps:

Step S1001: The DHCP client sends a DHCP Request message to the DHCP authentication agent. The DHCP Request message carries an auth-proto option, indicating that the client requires re-authentication. This message may be a unicast message or a broadcast message.

Step S1002: The DHCP authentication agent forwards the DHCP Request message that carries the auth-proto option to the DHCP authenticator or DHCP server. If the DHCP Request message sent by the DHCP client is a broadcast message, the message may be converted into a unicast message.

Step 1003: The DHCP authenticator or DHCP server sends a DHCP Auth-request message that carries an EAP request/identity message to the DHCP authentication agent.

Step S1004: The DHCP authentication agent forwards the DHCP Auth-request message that carries the EAP request/identity message to the DHCP client.

Step S1005: The DHCP client returns a DHCP Auth-response message that carries an EAP response/identity message to the DHCP authentication agent.

Step S1006: The DHCP authentication agent forwards the DHCP Auth-response message that carries the EAP response/identity message to the DHCP authenticator or DHCP server.

Step S1007: The DHCP authentication agent exchanges the DHCP Auth-request/Auth-response message that carries the EAP Method with the DHCP client.

Step S1008: The DHCP authentication agent exchanges the DHCP Auth-request/Auth-response message that carries the EAP Method with the DHCP authenticator or DHCP server.

Step S1009: The DHCP authenticator or DHCP server returns an authentication result to the DHCP authentication agent. In the authentication result, the EAP Success message is carried in a DHCP Ack message, and the EAP Failure message is carried in a DHCP Nack message. The DHCP Ack message carries an IP address, which may be an IP address reallocated by the DHCP authenticator or DHCP server to the DHCP client or may be the IP address obtained by the DHCP client through the first authentication.

Step S1011: The DHCP authentication agent forwards the authentication result to the DHCP client. In the authentication result, the EAP Success message is carried in a DHCP Ack message, and the EAP Failure message is carried in a DHCP Nack message. The DHCP Ack message carries an IP address, which may be the IP address reallocated by the DHCP authenticator or DHCP server to the DHCP client or may be the IP address obtained by the DHCP client through the first authentication.

The foregoing authentication method differs from the DHCP authentication process in the prior art in that: The DHCP authentication agent in this embodiment forwards the DHCP Auth-request between the DHCP client and the DHCP authenticator or DHCP server.

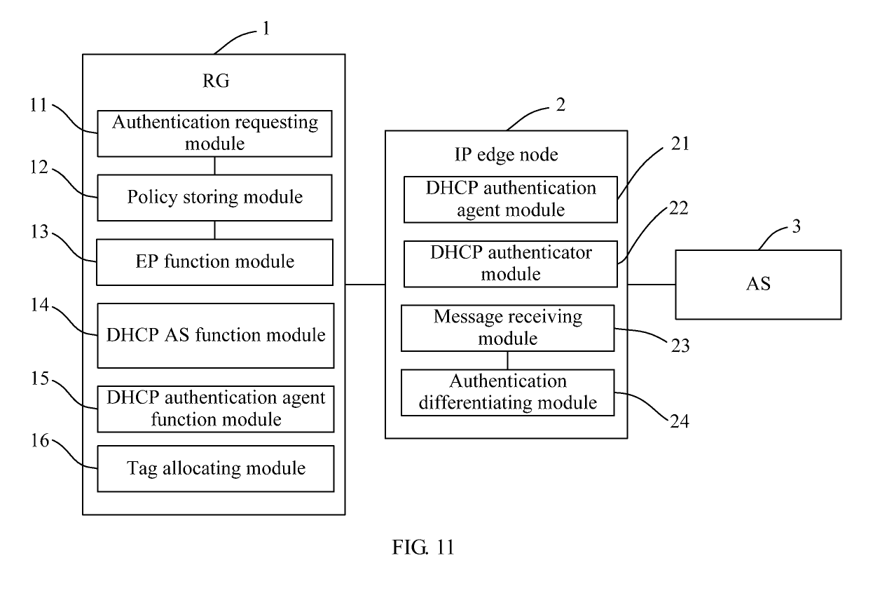

FIG. 11 shows a structure of a DHCP authentication system in an embodiment of the present invention. The system includes:

an RG 1, configured to: receive an access policy from the DHCP authenticator after being authenticated by an AS 3 that serves the RG 1, start the DHCP authentication according to the access policy, and perform DHCP authentication for the DHCP client connected to the RG 1;

an IP edge node 2, configured to: forward a DHCP authentication message, forward the message that comes from the RG 1 and carries a DHCP Discover message in broadcast or unicast mode, forward a DHCP forced-update message to the DHCP client, and deliver the access policy to the RG 1; and the AS 3, configured to authenticate the RG 1 that the AS 3 serves.

The RG1 includes:

an authentication requesting module 11, configured to enable the AS 3 that serves the RG 1 to authenticate the RG 1;

a policy storing module 12, connected to the authentication requesting module 11, and configured to store the access policy from the DHCP authenticator into an EP function module 13 after the RG 1 passes the authentication; and
the EP function module 13, configured to store and execute the access policy from the DHCP authenticator.

The IP edge node 2 includes:

a DHCP authentication agent function module 21, configured to: forward a DHCP authentication message, and forward the message which comes from the RG 1 and carries the DHCP Discover message in broadcast or unicast mode; and
a DHCP authenticator module 22, configured to send a DHCP forced-update message to the DHCP client and deliver an access policy to the RG 1.

The RG1 further includes a DHCP AS function module 14, which is configured to perform DHCP authentication for the DHCP client connected to the RG1.

The RG1 further includes a DHCP authentication agent function module 15, which is configured to: forward the DHCP Discover message from the DHCP client in broadcast or unicast mode, modify the source address of the message that carries the DHCP Discover message to the address of the DHCP authentication agent, and modify the destination address of the message that carries the DHCP Discover message to the next hop IP node address downloaded by the RG1 through an authentication protocol.

The RG1 further includes a tag allocating module 16, which is configured to allocate different VLAN tags to the messages of different authentication attempts.

The IP edge node 2 further includes:

a message receiving module 23, configured to receive the message that carries the DHCP Discover message sent by the RG 1; and

an authentication differentiating module 24, connected to the message receiving module 23, and configured to decide the forwarding address of the message that carries the DHCP Discover message received by the message receiving module according to the VLAN tag.

Through the DHCP authentication system described above, the RG 1 receives an access policy from the DHCP authenticator after being authenticated by an AS 3 that serves the RG 1, starts the DHCP authentication according to the access policy, and performs DHCP authentication for the DHCP client connected to the RG 1. Moreover, a DHCP AS function module 14 or DHCP authentication agent function module 15 is configured on the RG 1, and a DHCP authentication agent module 21 and a DHCP authenticator module 22 are configured on the IP edge node 2. Therefore, the DHCP authentication message can traverse the IP node and traverse different IP domains, thus making it possible to implement cross-IP domain wholesale services and laying a technical foundation for the next-generation IP-based access network.

After reading the foregoing embodiments, those skilled in the art are clearly aware that the present invention may be implemented through hardware, or through software in addition to a necessary universal hardware platform. The technical solution under the present invention may be embodied as a software product. The software product may be stored in a non-volatile storage medium (such as a CD-ROM, a USB flash disk, or a mobile hard disk), and may include several instructions that enable a computer device (such as a personal computer, a server, or a network device) to perform the methods provided in the embodiments of the present invention.

The above descriptions are merely exemplary embodiments of the present invention, and not intended to limit the scope of the present invention. Any modification, equivalent replacement, or improvement made without departing from the spirit and principle of the present invention should fall within the scope of the present invention.

What is claimed is:

1. A Dynamic Host Configuration Protocol (DHCP) authentication method, comprising:
authenticating a Routing Gateway (RG) by an Authentication Server (AS) that serves a RG;
receiving an access policy from a DHCP authenticator after the RG passes the authentication;
starting DHCP authentication according to the access policy; and
performing DHCP authentication for a DHCP client connected to the RG.

2. The DHCP authentication method of claim 1, wherein starting the DHCP authentication comprises:
starting the DHCP authentication agent of the RG if the DHCP authentication is performed through a DHCP authentication agent;
forwarding, by the DHCP authentication agent, a DHCP Discover message sent by the DHCP client in broadcast or unicast mode; and
modifying a source address of a message that carries the DHCP Discover message to an address of the DHCP authentication agent.

3. The DHCP authentication method of claim 2, wherein if forwarding the DHCP Discover message sent by the DHCP client in unicast mode, further comprising:
modifying a destination address of the message that carries the DHCP Discover message to a next hop Internet Protocol (IP) node address downloaded by the RG through an authentication protocol.

4. The DHCP authentication method of claim 3, further comprising:
receiving, by the IP edge node, the message that carries the DHCP Discover message if the next hop IP node is an IP edge node; and
deciding a forwarding address of the message that carries the DHCP Discover message according to each different Virtual Local Area Network (VLAN) tag allocated by the RG to each different authentication attempt.

5. The DHCP authentication method of claim 1, wherein the DHCP authentication performed for the DHCP client connected to the RG further comprises:
sending a DHCP forced-update message that carries an auth-proto option to the DHCP client;
receiving a DHCP Request message returned by the DHCP client, wherein the DHCP Request message carries the auth-proto option set by the DHCP client; and
forwarding the DHCP Request message that carries the auth-proto option to the DHCP authenticator or the DHCP server.

6. A Routing Gateway (RG), comprising:
an authentication requesting module, configured to enable an Authentication Server (AS) that serves the RG to authenticate the RG;
a policy storing module, connected to the authentication requesting module, and configured to store an access policy from a Dynamic Host Configuration Protocol (DHCP) authenticator into an Enforcement Point (EP) function module after the RG passes the authentication; and
the EP function module, configured to store and execute the access policy from the DHCP authenticator.

7. The RG of claim 6, further comprising:
a DHCP AS function module, configured to perform DHCP authentication for a DHCP client connected to the RG.

8. The RG of claim 7, further comprising:
a DHCP authentication agent function module, configured to: forward a DHCP Discover message from the DHCP client in broadcast or unicast mode, modify a source address of a message that carries the DHCP Discover message to an address of the DHCP authentication agent.

9. The RG of claim 8, wherein if the DHCP authentication agent function module configured to forward the DHCP Discover message sent by the DHCP client in unicast mode,
the DHCP authentication agent function module further configured to: modify a destination address of the message that carries the DHCP Discover message to a next hop Internet Protocol (IP) node address downloaded by the RG through an authentication protocol.

10. The RG of claim 6, further comprising:
a tag allocating module, configured to allocate different Virtual Local Area Network (VLAN) tags to messages of different authentication attempts.

11. An Internet Protocol (IP) edge node, comprising:
a Dynamic Host Configuration Protocol (DHCP) authentication agent function module, configured to: forward a DHCP authentication message, and forward a message which comes from a Routing Gateway (RG) and carries a DHCP Discover message in broadcast or unicast mode; and
a DHCP authenticator module, configured to send a DHCP forced-update message to a DHCP client and deliver an access policy to the RG.

12. The IP edge node of claim 11, further comprising:
a message receiving module, configured to receive the message that carries the DHCP Discover message sent by the RG; and
an authentication differentiating module, connected to the message receiving module, and configured to decide a forwarding address of the message that carries the DHCP Discover message received by the message receiving module according to a Virtual Local Area Network (VLAN) tag.

13. A Dynamic Host Configuration Protocol (DHCP) authentication system, comprising:
a Routing Gateway (RG), configured to: receive an access policy from a DHCP authenticator after being authenticated by an Authentication Server (AS) that serves the RG, start DHCP authentication according to the access policy, and perform the DHCP authentication for a DHCP client connected to the RG;
an Internet Protocol (IP) edge node, configured to: forward a DHCP authentication message, forward a message that comes from the RG and carries a DHCP Discover message in broadcast or unicast mode, forward a DHCP forced-update message to the DHCP client, and deliver the access policy to the RG; and
the AS, configured to authenticate the RG that the AS serves.

14. The DHCP authentication system of claim 13, wherein the RG comprises:
an authentication requesting module, configured to enable the AS that serves the RG to authenticate the RG;
a policy storing module, connected to the authentication requesting module, and configured to store the access policy from the DHCP authenticator into an Enforcement Point (EP) function module after the RG passes the authentication; and
the EP function module, configured to store and execute the access policy from the DHCP authenticator.

15. The DHCP authentication system of claim 14, wherein the RG comprises:
a DHCP AS function module, configured to perform DHCP authentication for a DHCP client connected to the RG.

16. The DHCP authentication system of claim 15, wherein the RG comprises:
a DHCP authentication agent function module, configured to: forward a DHCP Discover message from the DHCP client in broadcast or unicast mode, modify a source address of a message that carries the DHCP Discover message to an address of the DHCP authentication agent.

17. The DHCP authentication system of claim 16, wherein if the DHCP authentication agent function module configured to forward the DHCP Discover message sent by the DHCP client in unicast mode,
the DHCP authentication agent function module further configured to: modify a destination address of the message that carries the DHCP Discover message to a next hop Internet Protocol (IP) node address downloaded by the RG through an authentication protocol.

18. The DHCP authentication system of claim 13, wherein the IP edge node comprises:
a DHCP authentication agent function module, configured to: forward the DHCP authentication message, and forward the message which comes from the RG and carries the DHCP Discover message in broadcast or unicast mode; and
a DHCP authenticator module, configured to send a DHCP forced-update message to the DHCP client and deliver the access policy to the RG.

19. The DHCP authentication system of claim 18, wherein the IP edge node further comprises:
a message receiving module, configured to receive the message that carries the DHCP Discover message sent by the RG; and
an authentication differentiating module, connected to the message receiving module, and configured to decide a forwarding address of the message that carries the DHCP Discover message received by the message receiving module according to a Virtual Local Area Network (VLAN) tag.
